(19) United States
(12) Patent Application Publication
(10) Pub. No.: US 2009/0203276 A1
(43) Pub. Date: Aug. 13, 2009

(54) POLYMER ADDITIVE FOR PROVIDING AN ALCOHOL REPELLENCY FOR POLYPROPYLENE NONWOVEN MEDICAL BARRIER FABRICS

(75) Inventors: Michael KUTSENKO, Charlotte, NC (US); Stephen Fox, Charlotte, NC (US)

Correspondence Address: SUGHRUE MION, PLLC, 2100 PENNSYLVANIA AVENUE, N.W., SUITE 800, WASHINGTON, DC, 20037, US

(73) Assignee: Goulston Technologies, Inc., Monroe, NC (US)

(21) Appl. No.: 12/370,079

(22) Filed: Feb. 12, 2009

Related U.S. Application Data
(60) Provisional application No. 61/028,345, filed on Feb. 13, 2008.

(51) Int. Cl. B29C 47/00; B32B 5/02; C09D 191/00

(52) U.S. Cl. 442/84; 264/211; 106/270

(57) ABSTRACT

The present invention relates to a method for providing nonwoven polypropylene barrier composite fibrous structures with a surface that is both hydrophobic/alcohol repellent and durable to water/alcohol exposure. The method is based on the incorporation, into the nonwoven polypropylene barrier composite fibrous structure, of synergistic combinations of a new generation of non-telomer based fluorinated polymers with non-ionic hydrophobic waxes. When extruded with the polypropylene, these products result in a durable hydrophobic and alcohol repellent surface that is highly desirable to enhancing the utility of the nonwoven polypropylene barrier composite fibrous structures in a wide range of applications and products, ranging from medical to various construction applications.

### FIELD OF THE INVENTION

The present invention relates to a composition that, when incorporated into various layers of non-woven polypropylene barrier composite fibrous structures before or during the extrusion thereof, results in a highly hydrophobic water/alcohol repellent surface on the polypropylene and also relates to a method for generating such a hydrophobic and water/alcohol repellent surface on polypropylene non-woven fabrics.

### BACKGROUND OF RELATED TECHNOLOGY

Many applications of nonwoven polypropylene barrier composite fibrous structures require surfaces with higher levels of hydrophobicity and water/alcohol repellency than are provided by the original polypropylene resins to support the performance demands of final products produced from these structures. Such surfaces are typically characterized by their surface energy, which is probed by any number of analytical tests (contact angle with water or other appropriate liquids, water column, wetting force, etc.) that allow the characterization of the water/alcohol repellent nature of the surface. Such techniques provide a direct indication of the degree of hydrophobicity and water/alcohol repellency of the surface, and with increasing hydrophobicity (or lower surface energy), directly relate to a range of end use properties in the fabric, ranging from water/alcohol repellency in medical fabrics to improved water barrier properties in under laying roofing materials. Such nonwoven polypropylene barrier composite fibrous structures have significantly enhanced utility in a wide range of applications, ranging from, but not limited to, specialty medical barrier fabrics and protective wear such as surgical gowns, drapes, etc., and under laying roofing materials. While there has been considerable activity in this area in the past, products previously developed have not been able to efficiently provide the highly water/alcohol repellent surface, together with the high level of barrier properties, required by most of these applications.

Much of the early work in this area covered the direct application of specific materials into some of the layers of nonwoven polypropylene barrier composite fibrous structures and on to the surface of the formed product. Examples of patented technologies in this area include the following:
Pat. No. 00815306/EP-B 1 related to protective garments formed from nonwoven fabrics having improved particulate barrier properties.
U.S. Pat. No. 5,151,321 covering method of making conductive, water and/or alcohol repellent nonwoven fabric and resulting product.
U.S. Pat. No. 5,597,647 covering protective laminate having barrier properties which has a first outer layer having liquid repellency through the use of an internal, low surface tension liquid repellency additive and a bulky second outer layer having liquid absorbency through use of an internal wetting agent, where the layers are bonded to form a laminate.
Pat. No. 0683260/EP-B1 covering nonwoven absorbent polymeric fabric exhibiting improved fluid management and methods for making the same.
Pat. No. 00742305/EP-B1 described the invention related to laminated fabric which is permeable to gas and/or vapor but possesses water droplet and solid particle barrier properties.

Typically such prior art non-woven polypropylene barrier composite fiber structures are based on C₈ fluorocarbons, which, as is known in the art, serve as a source of undesirable PFOA.

### SUMMARY OF THE INVENTION

The present invention relates to a composition that, when incorporated into various layers of nonwoven polypropylene barrier composite fibrous structures during the extrusion process used to form the same, results in a highly hydrophobic water/alcohol repellent surface on the polypropylene. The presence of this composition in one or more layers of nonwoven polypropylene barrier composite fibrous structure provides significant performance improvements in the barrier properties of the above mentioned structures at the following points:
Resistance to water penetration, measured as water column or hydrostatic head (HSH);
Water/Alcohol repellency;
Mechanical strength in both machine and cross-machine directions;
Softness.

Such a surface on a nonwoven polypropylene barrier composite fibrous structure is highly desirable to enhancing the utility of above mentioned structures in a wide range of applications and products, ranging from medical to various construction applications.

The present invention also provides an efficient, effective method for generating a hydrophobic and water/alcohol repellent surface on polypropylene nonwoven fabrics. The method is based on the incorporation of a combination of new generation of non-telomer based fluorinated polymers with non-ionic hydrophobic waxes into the polymer before or during extrusion, resulting in a polymer product that has improved hydrophobicity and water/alcohol repellency (low surface energy, improved hydrophobic behavior, etc.) and this resultant hydrophobic surface is durable to water and alcohol exposure under a range of conditions, even those that normally result in the removal of such materials, with the resultant loss of the hydrophobic and water/alcohol repellency effect.

We have found that certain classes of materials, when combined, function synergistically, resulting in enhanced water/alcohol repellent performance at relatively low concentrations. This is desirable in that it minimizes the effect of the additive on the properties of the basic polymers. In addition, we have determine that through the selection of specific materials, products can be designed that provided enhanced durability and maintain their repellent performance even after significant and multiple exposures to water and alcohol based systems. These materials also work as processing aids during high speed extrusion improving processability of the modified polypropylene.

### DETAILED DESCRIPTION OF THE INVENTION

The present invention is based on the use of a blend of two or more components, one of which is selected from perfluorinated esters which do not originate from a telomer alcohol where the fluorocarbon length does not exceed six atoms and the other of which is a hydrophobic, non-ionic wax. One or more perfluorinated esters may be used in combination with one or more hydrophobic, non-ionic waxes.

In accordance with the present invention, the perfluorinated esters contain an aliphatic portion which is fully fluorinated, i.e., all of the hydrogens present in the aliphatic portion (the fluorocarbon length) are replaced with fluorine.

The perfluorinated esters in accordance with the present invention are straight chain esters involving straight chain alkyl groups. The fluorocarbon portion is typically a C₁-C₆ fluorocarbon, more preferably a fully fluorinated C₄-C₆ straight chain alkyl group.

Examples of useful perfluorinated esters are given below:

Ester (1) CF₃(CF₂)ₙCH₂CH₂COOR; where n≦5, and R is alkyl chain of various length.

For the Ester (1) materials of the formula CF₃ (CF₂)n CH₂CH₂COR, while n is equal to or less than 5, generally n will be from 1-5. While R can be an alkyl chain of various lengths, generally speaking R is greater than 16. The maximum number of carbon atoms in R is not overly important, but as a practical matter in the industry, the maximum number of carbon atoms in R will normally be 24.

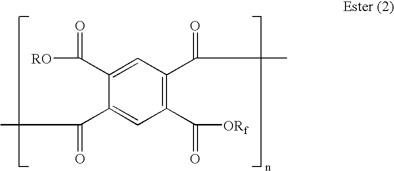

where R is long chain (n>16) alkyl, and R_{f} is C₄-C₆ fluorocarbon and n>4.

For the Ester (2) materials, the same limits on R as have been provided regarding the Ester (1) materials apply, i.e., generally R will be a C₁₆-C₂₄ straight chain alkyl group. With respect to n being greater than 4, usually n will have a maximum value of 10.

The terminals or termination groups in the Ester (2) materials are not overly important, but normally these will be a methyl group

Ester (3) CF₃(CF₂)ₙCOOR; where R—is alkyl sulfonate or urethane chain and n≦5.

For the Ester (3) compounds, the urethane chain materials will generally be thermoplastic.

The hydrophobic non-ionic waxes are now discussed.

The second of which is selected from the group:

Hydrophobic non-ionic waxes.

Wax (1) Linear and branched hydrocarbon waxes: examples—paraffin wax, polyethylene wax, etc. (CH₃(CH₂)ₘCH₃, where m is typically >20).

Wax (2) Ester waxes: examples—stearyl stearate, hydrogenated soy bean oil, ethylene glycol distearate, etc. (CH₃(CH₂)ₘ—CO—O—(CH₂)ₙCH₃ where m and n are 7 to 21).

Wax (3) Amide waxes: examples—stearyl stearamide, ethylene diamine distearate, erucamide, etc. (CH₃(CH₂)ₘ—CO—NH—(CH₂)ₙCH₃ where m and n are 7 to 21).

The fluorinated esters and waxes are all conventional materials, many of which are commercially available.

It will be noted that for each of Wax (1), Wax (2) and Wax (3) that the discussion contains a formula. The formula is generic to the materials discussed just prior to the formula.

For Wax (1), there is no maximum limitation on m.

The final compositions for use in the polymer are composed of at least 2 components, one from each of the above two classes. Each component makes up 10 to 60% by weight of the final composition, with the total of these two components making up at least 75% by weight of the final composition. Other components may be added to the composition, including mineral oils, vegetable and petroleum waxes, other non-ionic products, etc. These other materials may comprise up to 25% by weight of the final composition.

The compositions are then put into a form that is acceptable to the industry [concentrates (<50% active material in polymer matrix by weight based on the weight of active material and polymer matrix), super concentrates (>50% active material in polymer matrix by weight based on the weight of active material and polymer matrix), and they may be in direct injectable form, etc., and can be supplied to polypropylene extruders for incorporation into the polymer. The products are then incorporated into the extrudate such that there is 0.5 to 5% by weight of the active composition in the resultant non-woven polypropylene barrier composite fibrous structure based on the weight of the resultant nonwoven polypropylene barrier composite structure.

For example, the concentrate or superconcentrate can be added into the polypropylene melt as part of a master batch, and the polypropylene then extruded.

As an alternative, if the extrusion line will permit the addition of components, then the concentrates or super concentrates can be blended into the polypropylene pellets which are typically melted and extruded.

As used herein the term “nonwoven fibrous structure” and like terminology used to describe the product of the present invention means a web having a structure of individual fibers or threads which are interlaid, but not in a regular, identifiable manner as in a knitted fabric. Nonwoven fabrics or webs have been formed from many processes such as for example, meltblowing processes, spunbonding processes, and bonded carded web processes.

As used herein the term “spunbonded fibers” refers to small diameter fibers which are formed by extruding molten thermoplastic material as filaments from a plurality of fine, usually circular capillaries of a spinnerette with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,502,538 to Levy, and U.S. Pat. No. 3,542,615 to Dobo et al. Spunbond fibers are generally not tacky when they are deposited onto a collecting surface and require an additional thermal, adhesive or other bonding step to integrate the web. Spunbond fibers are generally continuous and have diameters larger than 7 microns.

As used herein the term “meltblown fibers” means fibers formed by extruding a molten thermoplastic material through a plurality of fine, usually circular, die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin. Meltblown fibers are microfibers which may be continuous or discontinuous, are generally smaller than 10 microns in diameter, and are generally tacky and self-bonding when deposited onto a collecting surface.

The composite fibrous structure of the present invention includes, by necessity, polypropylene fabrics, and preferably contains only polypropylene as the sole polyolefin. Typically the composite fibrous structure of the present invention comprises a plurality of spunbonded polypropylene fibers having a diameter or denier of 10 μm-15 μm in combination with meltblown polypropylene fibers having a diameter or denier of 1-2 microns.

In accordance with the present invention, the spunbonded extruded polypropylene fibers have a different melt flow index or melt flow rate than the meltblown polypropylene fibers. The spunbonded polypropylene fibers will typically have a melt flow index or melt flow rate of 20-50 whereas the meltblown polypropylene fibers will typically have a melt flow index or melt flow rate of from 800-2,500.

As examples of the melt blown composite fibrous structure of the present invention, the structure may have the SMS form, SMMS form, the SSMMS form, the SSMMMS form, etc. All may be successfully used in accordance with the present invention.

In accordance with the present invention, there is obtained a highly hydrophobic water/alcohol repellent surface. In accordance with the present invention, a surface is considered highly hydrophobic and water/alcohol repellent when it has a contact angle with water of about 90° or above. Depending on the accuracy of measurement, contact angles with water as high as 120 to 130° can be achieved.

When the term “barrier composite fiber structure” and like terminology is used in the present specification to describe the product of the present invention, this means a structure which comprises two or more polypropylene fabric layers, which include at least one spunbonded polypropylene layer and at least one meltblown polypropylene layer which will repel water but, at the same time, will provide a breathable composite fiber structure. It is central to the present invention that the differing polypropylene layers which are extruded having a different diameter or denier and different melt flow index/melt flow rate properties as earlier explained for the spunbonded polypropylene and the meltblown polypropylene.

The process or method of present invention is based upon the fact that it is faster to produce spunbonded polypropylene fibers than it is to produce meltblown polypropylene fibers. In accordance with the present invention, the method of the present invention provides improved productivity and quality. Typically a spunbonded polypropylene layer is extruded onto a belt, laid down and solidified, and extruded meltblown polypropylene layer is extruded on top of the spun bonded polypropylene fibers and laid down and solidified, etc.

In the sense of the present invention, a “barrier composite fibrous structure” is one which would withstand the pressure of water so that the same is substantially impermeable but which, at the same time, will be breathable.

As will be apparent to one of skilled in the art, the present invention is well suited for the preparation of hydrophobic/alcohol repellent nonwoven polypropylene barrier composite fibrous structures. We have developed, associated with this program, many examples, along with supporting data and all this will be present as part of the patent which we intend to pursue. Accordingly, while the present invention has been shown and described herein, it is to be understood that the foregoing description and accompanying drawings are offered by way of illustration only and not as a limitation.

What is claimed:

1. A composition for providing a hydrophobic water/alcohol repellent surface on a non-woven polypropylene barrier composite which comprises a perfluorinated ester and a hydrophobic non-ionic wax, wherein the perfluorinated ester and the hydrophobic non-ionic wax each comprises 10 to 60% by weight of the composition making up a total of at least 75% by weight of the composition, with other components which do not harmfully affect the hydrophobic water/alcohol repellent properties of the non-woven polypropylene barrier composite comprising up to 25% of the composition.

2. The composition of claim 1, wherein the perfluorinated ester is a straight chain ester comprising straight chain alkyl groups where a fluorocarbon portion thereof is a C₁-C₆ fluorocarbon.

3. The composition of claim 1, wherein the perfluorinated ester has the formula CF₃(CF₂)ₙCH₂CH₂COOR; where n≦5, and R is alkyl chain with greater than 16-24 carbon atoms.

4. The composition of claim 1, wherein the perfluorinated ester has the formula 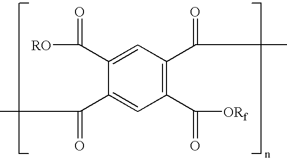
where R is a C₁₆-C₂₄ straight chain alkyl group, R_{f} is C₄,-C₆ fluorocarbon and n is 4-10.

5. The composition of claim 1, wherein the perfluorinated ester has the formula CF₃(CF₂)ₙCOOR; where R is an alkyl sulfonate or urethane chain and n≧5.

6. The composition of claim 1, wherein the hydrophobic non-ionic wax has the formula CH₃(CH₂)ₘCH₃, where m is >20.

7. The composition of claim 1, wherein the hydrophobic non-ionic wax has the formula (CH₃(CH₂)ₘ—CO—O—(CH₂)ₙCH₃ where m and n are 7-21).

8. The composition of claim 1, wherein the hydrophobic non-ionic wax has the formula (CH₃(CH₂)ₘ—CO—NH—(CH₂)ₙCH₃ where m and n are 7-21).

9. A non-woven polypropylene barrier composite which comprises a surface having thereon a perfluorinated ester and a hydrophobic non-ionic wax, wherein the perfluorinated ester and the hydrophobic non-ionic wax each comprises 10 to 60% by weight of the composition making up a total of at least 75% by weight of the composition, with other components which do not harmfully affect the hydrophobic water/alcohol repellent properties of the non-woven polypropylene barrier composite comprising up to 25% of the composition.

10. The composite of claim 9, wherein the perfluorinated ester is a straight chain ester comprising straight chain alkyl groups where a fluorocarbon portion thereof is a C₁-C₆ fluorocarbon.

11. The composite of claim 9, wherein the perfluorinated ester has the formula CF₃(CF₂)ₙCH₂CH₂COOR; where n≦5, and R is alkyl chain with greater than 16-24 carbon atoms.

12. The composite of claim 9, wherein the perfluorinated ester has the formula 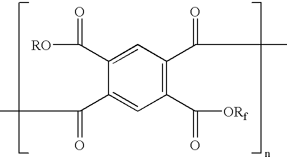
where R is a C₁₆-C₂₄ straight chain alkyl group, R_{f} is C₄,-C₆ fluorocarbon and n is 4-10.

13. The composite of claim 9, wherein the perfluorinated ester has the formula CF₃(CF₂)ₘCOOR; where R is an alkyl sulfonate or urethane chain and n≧5.

14. The composite of claim 9, wherein the hydrophobic non-ionic wax has the formula CH₃(CH₂)ₘCH₃, where m is >20.

15. The composite of claim 9, wherein the hydrophobic non-ionic wax has the formula (CH₃(CH₂)ₘ—CO—O—(CH₂)ₙCH₃ where m and n are 7-21).

16. The composite of claim 9, wherein the hydrophobic non-ionic wax has the formula (CH₃(CH₂)ₘ—CO—NH—(CH₂)ₙCH₃ where m and n are 7-21).

17. A process for forming a hydrophobic water/alcohol repellent surface on a non-woven polypropylene barrier composite which comprises adding to polypropylene which is to form the non-woven polypropylene barrier composite a composition which comprises a perfluorinated ester and a hydrophobic non-ionic wax, wherein the perfluorinated ester and the hydrophobic non-ionic wax each comprises 10 to 60% by weight of the composition making up a total of at least 75% by weight of the composition, with other components which do not harmfully affect the hydrophobic water/alcohol repellent properties of the non-woven polypropylene barrier composite comprising up to 25% of the composition, and then extruding the polypropylene containing said composition, whereby the composition is incorporated in an amount such that there is 0.5 to 5% by weight of the composition in the resultant non-woven polypropylene barrier composite.

18. The process of claim 17, wherein the perfluorinated ester is a straight chain ester comprising straight chain alkyl groups where a fluorocarbon portion thereof is a C₁-C₆ fluorocarbon.

19. The process of claim 17, wherein the perfluorinated ester has the formula CF₃(CF₂)ₙCH₂CH₂COOR; where n≦5, and R is alkyl chain with greater than 16-24 carbon atoms.

20. The process of claim 17, wherein the perfluorinated ester has the formula 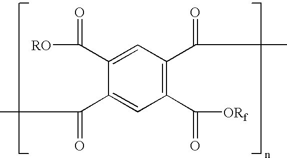
where R is a C₁₆-C₂₄ straight chain alkyl group, R_{f} is C₄, -C₆ fluorocarbon and n is 4-10.

21. The process of claim 17, wherein the perfluorinated ester has the formula CF₃(CF₂)ₙCOOR; where R is an alkyl sulfonate or urethane chain and n≦5.

22. The process of claim 17, wherein the hydrophobic non-ionic wax has the formula CH₃(CH₂)ₘCH₃, where m is >20.

23. The process of claim 17, wherein the hydrophobic non-ionic wax has the formula (CH₃(CH₂)ₘ—CO—O—(CH₂)ₙCH₃ where m and n are 7-21).

24. The process of claim 17, wherein the hydrophobic non-ionic wax has the formula Wax (CH₃(CH₂)ₘ—CO—NH—(CH₂)ₙCH₃ where m and n are 7-21).
